(19) United States
(12) Patent Application Publication
(10) Pub. No.: US 2019/0362647 A1
(43) Pub. Date: Nov. 28, 2019

(54) Magnetic Vinyl Sticker Coding Folder

(71) Applicant: Steven Brian Robinson, Sao Paulo (BR)

(72) Inventor: Steven Brian Robinson, Sao Paulo (BR)

(21) Appl. No.: 15/822,002

(22) Filed: May 24, 2018

(51) Int. Cl. G09B 19/00; G06F 3/041

(52) U.S. Cl. CPC G09B 19/0053; G06T 19/006; G06F 3/0416

(57) ABSTRACT

A composite butterfly-shaped folder, comprised of cardboard-base (or recycled tire rubber, or similar), single magnetic surface on main workspace, with twin inward-folding lapels with twin magnetic surfaces (either side) and twin lateral carry-handles, Velcro closure, Stylus pen holder, Stylus pen (Optional) and Augmented Reality (AR) markings on folder workspace margins to be used in conjunction with Smartphone and/or tablet and/or AR glasses (Optional). Self-contained study folder for students to use both in classroom environment and at home, with compact stowaway profile and magnetic vinyl stickers enabling a range of subjects to be studied with pieces held in place magnetically. Electric wiring grid and Bluetooth port with rechargeable mini-solar panel allowing use in rural areas with no reliable mains electricity, and offline checking of study sequences via electric wiring grid. Resolves current dependence on tablets, making use of wider and more affordable availability of smartphones.

### FIELD OF THE INVENTION

This invention relates to initiatives employing the MIT Media Lab open-source programming or coding language, Scratch®, a drag-drop graphic coding language for kids, designed to empower schoolchildren to take an active interest in coding. The invention also provides a blended-learning platform for a range of curricular subjects via the use of different affordable kits of magnetic vinyl stickers.

### DISCUSSION OF RELATED ART

Coding initiatives based around Scratch®, currently limit access to PCs (desktop/laptop-notebook) and/or tablets. This is because in order to fully accommodate the 03 basic areas for coding to occur, (a) workspace (b) block (command) storage area (c) creation screen, the only current option is to present all three simultaneously on a sufficiently-sized screen, hence limiting access to individuals, families or institutions with PCs or tablets.

Smartphone screens on their own do not possess sufficient width or height to be able to accommodate these 3 areas, without having to relegate areas to separate windows, closing one or another. This is disruptive on a cognitive level, since attempting to code a sequence in the workspace, then overlapping this same area with the screen in order to activate or run the sequence created, detracts from an actual comprehension of the task at hand. By way of analogy, it is asking kids to write an essay by writing out a phrase, then turning the page to read the essay to that point, constantly turning the page back and forth in order to progress.

Restricting Coding initiatives to the ownership and/or availability of a PC or tablet, is preventing lower income families and institutions from benefiting from these coding initiatives simply because they do not have the means to equip themselves with PCs or tablets.

Paradoxically, the primary argument behind mainstream coding initiatives such as Code.Org (http://www.code.org) is to empower the next generation for entry into an increasingly Artificial Intelligence (AI)-driven employment scenario, in which knowledge of coding or coding literacy will be crucial to job prospects. This is reflected in the User statistics for this website: >544 million individual Users have visited the website and used the Hour of Code section, but only 25.9 million have subsequently enrolled with the site, free-of-charge. If only 1 in 21 Users are enrolling, this tends to suggest that the vast majority accessing are low income, accessing via a school or institutional PC/tablet, or Internet Café, but have no means to continue studying at home.

Families increasingly opt to purchase smartphones instead of PCs and tablets even lesser so, as smartphone use is far more ubiquitous, mobile data plans are cheaper and provide more reliable access, in addition to a myriad of other features and a degree of mobility that even tablets lack.

Therefore there is a pressing need to offer the already confirmed half billion Users of the Code.Org website, who have not since continued to enroll with the website, effective means to empower themselves through Coding, by offering a self-contained, highly portable Coding workspace, the Coding Folder, which operates in conjunction with any smartphone (and/or tablet), at a fraction of the cost to consumers when compared to the price of current options (PCs, laptops/notebooks and tablets).

As the magnetic vinyl stickers employed can be laser cut to any format and size, the Folder itself also simultaneously acts as a blended learning platform, as different kits of magnetic vinyl stickers can be produced for difficult curricular subjects Sciences—(Physics, Chemistry and Biology), Languages (English as a Second/Foreign language for students of Portuguese, Spanish, Italian, French, Hindi and Mandarin), as well as large-size one piece magnetic vinyl stickers with full-color printed images of the popular Microsoft Office Software Applications (Word, Excel, PowerPoint) covering the entire surface of the folder workspace and allowing pen strokes with a Stylus pen (optional) on the surface of the large one piece magnetic vinyl sticker to be picked up via the Bluetooth connection to a Smartphone, converting handwriting into printed text on a smartphone and/or tablet screen.

As UNESCO estimates 2.7 billion students by 2035 actively involved in studying, and insufficient planning and provision for teaching institutions to serve this increased demand, students in the coming decades will need an affordable learning platform that can be powered off-the-grid (solar-power) and run offline (no Wi-Fi requirement), in conjunction with a basic smartphone, but which provides ACTIVE cognitive interaction, as opposed to current touchscreen-dependence initiatives (high price barrier+PASSIVE user experience).

### SUMMARY OF THE INVENTION

The present invention includes a composite cardboard folder that opens up like a butterfly, comprised of an outer base ply of standard cardboard laminated on one side with a full-color illustration plus a film coating to render a gloss finish, and an inner base layer infused with magnetic filings in the glue used to create the inner cardboard ply, rendering it magnetic on the inner side, laminated again with a full-color illustration that employs the use of PWB (printed wiring board) circuitry to provide a grid across the folder workspace and where necessary filament-fine wires to enable connections to the battery power source via a mini solar-powered array and Bluetooth connector, plus a film coating to render a gloss finish. This folder has a central crease, allowing the folder to close in on itself, with additional flaps or lapels set back from the outer edge on either side, of a width that permits these to remain folded within the closed folder, or opened out to extend the width of the folder itself. The two flaps or lapels are comprised of the same composite cardboard ply structure as the folder, except each flap or lapel is magnetic on either side, that is, whilst the folder itself is only magnetic on the inner side, either flap or lapel is comprised of a two-ply cardboard laminate, infused with magnetic filings on either side, laminated with a full-color illustration, plus a film coating to render a gloss finish. A carry-handle is cut out of either side of the laminated cardboard folder and Velcro fasteners affixed below the aperture of the carry-handle to ensure folder remains closed for easy storage and portability. An elastic Stylus penholder is attached to the left side of the left flap in order to house a Stylus pen (optional).

Magnetic vinyl stickers are provided, laser-cut from sheets of magnetic vinyl, fashioned into the respective curricular subject elements, i.e.: for Coding purposes, these are sets of commands or blocks as used by the open-source coding initiative created and launched by MIT Media Lab—Scratch. Each vinyl sticker has a micro-led affixed to the upper surface and wiring contacts on the underside, enabling vinyl stickers to ‘adhere’ to the magnetic flaps or lapels for storage purposes (when not in use), or ‘adhere’ to the magnetic folder workspace, permitting the respective wiring contacts to complete a circuit via the circuitry grid. Completing circuits enables the identity of each magnetic vinyl sticker to be transferred to the Bluetooth connector and via Bluetooth transmission to the 10S/Android-based App. Sequences assembled on the folder workspace by children are hence mapped onto App screen on an available compatible smartphone and/or tablet, permitting micro-LEDs affixed to each respective vinyl sticker to light up (green or red), informing whether a given sequence is correct or not. Variables necessary when Coding (in Scratch) are requested within the App on smartphone and/or tablet screen as vinyl stickers are ‘adhered’ to folder workspace, permitting kids to actively CREATE coding sequences and subsequently press on the PLAY or RUN button offered on the App screen, in order to see their creations on a screen.

The present invention applies PWB (printed wiring board) and/or filament wiring circuitry to an existing magnetic cardboard and vinyl sticker ONLY concept, to provide a safely functioning, esthetically appealing, compact and easily transportable blended learning platform. The folder is easy to store and readily portable, the workspace as classroom learning platform is self-contained and of a low-profile (folders can be stacked in a very small space for storage), or children can take them home to continue their studies, connecting to the smartphone/tablet of a family member. The features and advantages of this invention mean that both lower income families worldwide with no tablet access but smartphone access (far more ubiquitous) can purchase the folder, at a tenfold reduction in estimated retail price when compared to the current requirement to have either a tablet or PC (desktop/laptop-notebook) available, on which to pursue current Coding initiatives (e.g. Code.Org). On an institutional level, the features and advantages are both pecuniary and pedagogical—schools no longer have to depend on the purchase of one tablet per child, a teacher can use their own smartphone and connect in sequence to each folder to check on each child's progress. At the lowest income levels, currently there is no option available to either institutions or families. Since smartphones are ubiquitous and increasingly so, the Coding Folder resolves this technological-financial hurdle. On a ludic-pedagogical level, the cognitive benefits of children ‘assembling’ vinyl stickers within an ACTIVE 3D-setting are far superior to the PASSIVE 2D-setting of merely swiping a finger on a touchscreen in a ‘drag&drop’ PC/tablet environment.

### DESCRIPTION OF THE DRAWINGS

FIG. 1A is an exploded cross-sectional view of single-sided non-magnetic outer surface.

FIG. 1B is an exploded cross-sectional view of single-sided magnetic flap/lapel.

FIG. 1C is an exploded cross-sectional view of single-sided non-magnetic outer surface back-to-back with single-sided magnetic surface.

FIG. 1D is a perspective view of side margins with carry handles.

FIG. 1E is a perspective view of main workspace area.

FIG. 1F is an exploded cross-sectional view of double-sided magnetic flaps/lapels.

FIG. 1G is an exploded cross-sectional view of fully-extended magnetic workspace area including both flaps/lapels.

FIG. 1H a semi-open perspective view of main workspace area.

FIG. 1I is a fully-open perspective view of main workspace area.

FIG. 1J is a fully-closed perspective view of folder with both flaps/lapels stowed.

FIG. 2A is a perspective view of a large-size one-piece magnetic vinyl sticker.

FIG. 2B is a perspective view of a large-size one-piece magnetic vinyl sticker raised above magnetic workspace.

FIG. 2C is an exploded cross-sectional view of a large-size one-piece magnetic vinyl sticker.

FIG. 3A is a perspective view of typical coding magnetic vinyl sticker.

FIG. 3B is an exploded cross-sectional view of a typical coding magnetic vinyl sticker.

FIG. 4 is a perspective view of a typical coding magnetic vinyl sticker sequence.

FIG. 5 is a perspective view of a typical Physics magnetic vinyl sticker sequence.

FIG. 6 is a perspective view of a typical English language (ESL/EFL) magnetic vinyl sticker sequence.

FIG. 7A is a perspective view of a typical coding magnetic vinyl sticker including an Augmented Reality (AR) marker.

FIG. 7B is an exploded cross-sectional view of a typical coding magnetic vinyl sticker including an Augmented Reality (AR) marker.

### DETAILED DESCRIPTION OF THE PREFERRED EMBODIMENT

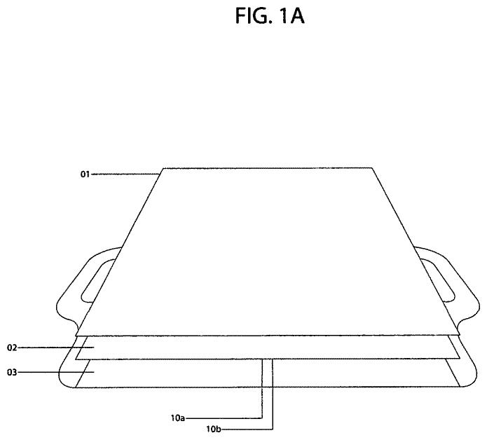

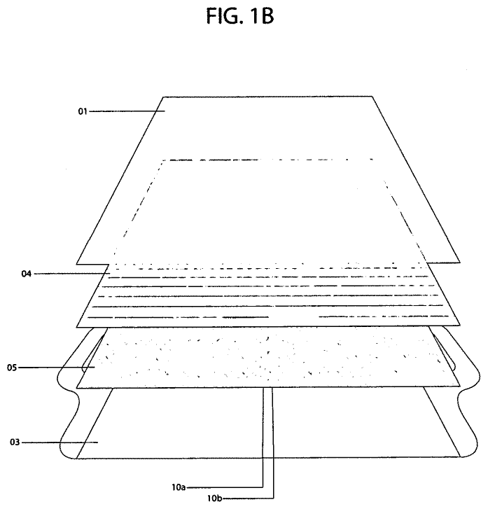

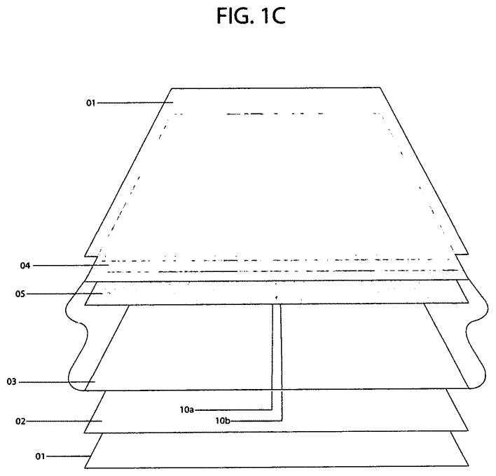

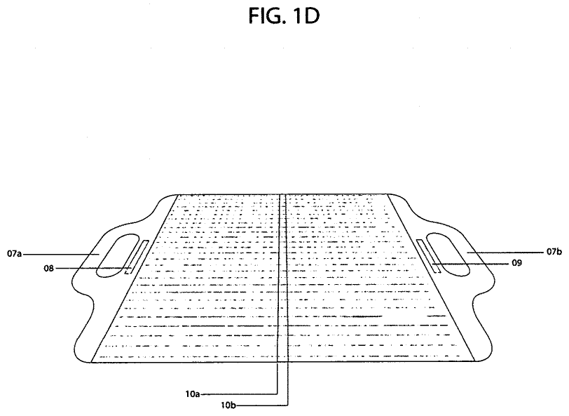

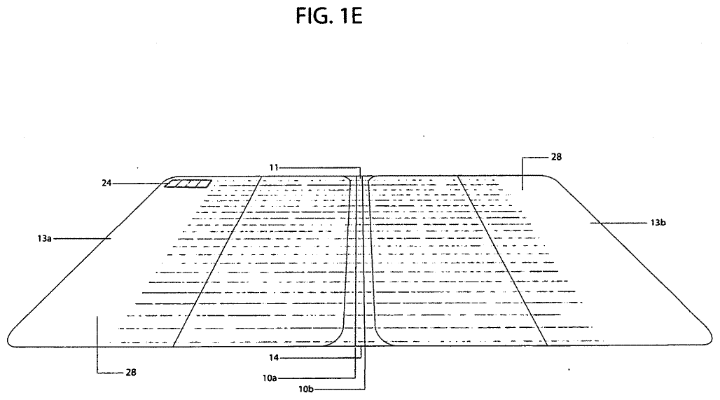

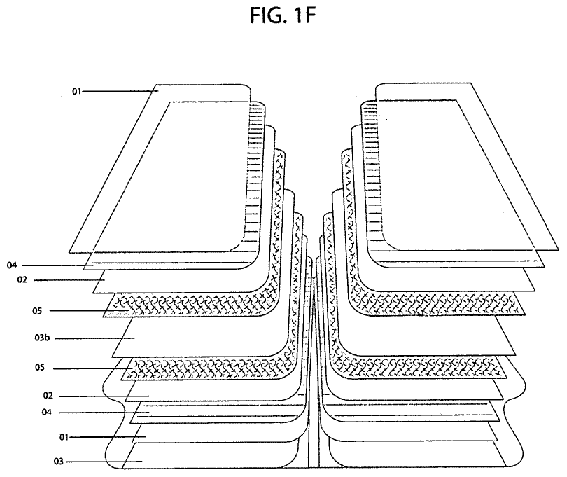

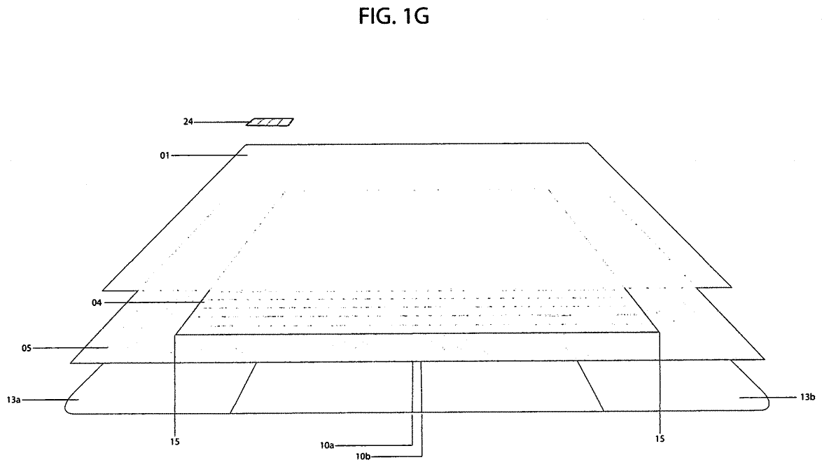

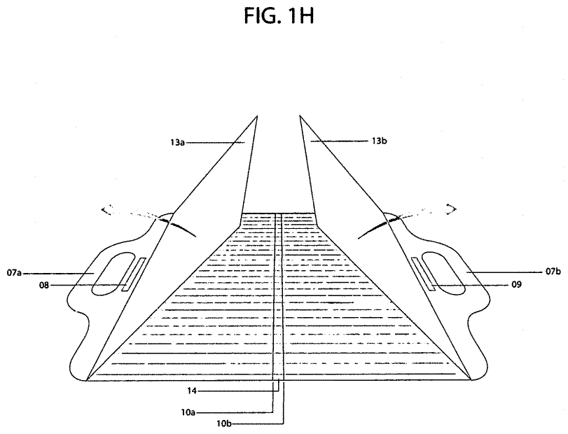

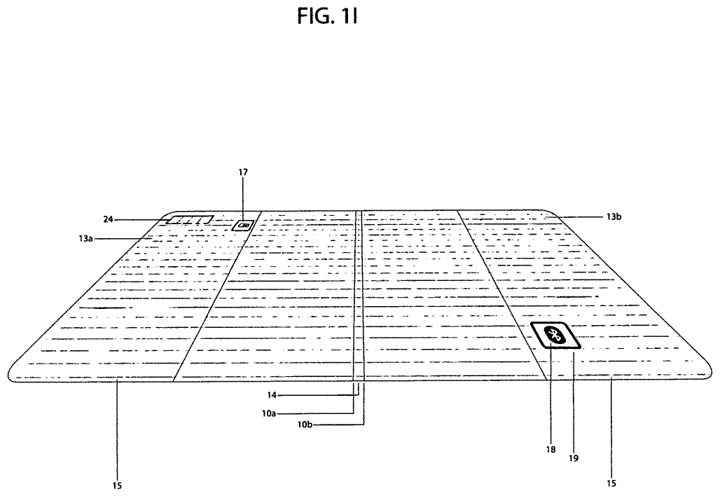

Referring to FIG. 1A is an exploded cross-sectional view of the single-sided composite laminated cardboard, comprising 01 outer film, 02 full-color printed leaf, 03 standard cardboard filler, with twin embossed central folding creases 10a and 10b.

Referring to FIG. 1B is an exploded cross-sectional view of the single-sided composite laminated cardboard, comprising 01 outer film, 04 full-color printed leaf incorporating PWB (printed wiring board) and/or filament wiring grid, 05 magnetic filament infused (glue-based) cardboard filler, 03 standard cardboard filler, with twin embossed central folding creases 10a and 10b.

Referring to FIG. 1C is an exploded cross-sectional view of FIGS. 1A and 1B mounted back-to-back to form the basic workspace of the folder: the single-sided composite laminated cardboard, comprising 01 outer film, 04 full-color printed leaf incorporating PWB (printed wiring board) and/or filament wiring grid, 05 magnetic filament infused (glue-based) cardboard filler with contact points cut into PWB (printed wiring board) and/or filament wiring grid via which magnetic vinyl stickers form circuit connections, 03 standard cardboard filler, with twin embossed central folding creases 10a and 10b, with the single-sided composite laminated cardboard, comprising 01 outer film, 02 full-color printed leaf, 03 standard cardboard filler, with twin embossed central folding creases 10a and 10b, beneath.

Referring to FIG. 10 is a perspective view of side margins illustrating carry-handles 07a and 07b cut out of these side margins, on either side, and white Velcro fastener 08 and receptor 09 affixed, respectively, to either side, enabling folder to close in on itself, with twin embossed central folding creases 10a and 10b.

Referring to FIG. 1E is a perspective view of main workspace with both flaps/lapels 13a and 13b open, a composite laminated cardboard ply with two central creases 10a and 10b embossed into centerline 14 along vertical axis, 1 cm apart 11, permitting closure of folder with sufficient clearance for either flap/lapel to stow alongside main workspace, within closed profile perspective FIG. 1J. Augmented Reality (AR) markers 28 and mini-solar power source strip 24 are shown on side margins.

Referring to FIG. 1F is an exploded cross-sectional view of double-sided magnetic flaps/lapels—comprising 01 outer film, 04 PWB (printed wiring board) and/or filament wiring grid, 02 full-color illustration, 05 magnetic filament infused (glue-based) cardboard filler, 03b basic cardboard filler, and identical reverse sequence of 05 magnetic filament infused (glue-based) cardboard filler, 02 full-color illustration, 04 PWB (printed wiring board) and/or filament wiring grid, 01 outer film and 03 standard cardboard filler.

FIG. 1G is an exploded cross-sectional view of fully-extended magnetic workspace area including both flaps/lapels open 13a and 13b, comprising 01 outer film, 04 PWB (printed wiring board) and/or filament wiring grid, 05 magnetic filament infused (glue-based) cardboard filler, comprising main workspace 15 with extent of circuit connections (grid) and battery charge indicator 24, overlying base with two central creases 10a and 10b embossed.

Referring to FIG. 1H is a semi-open perspective view illustrating from outwards-inwards on either side of centerline 14 along vertical axis, two carry-handles 07a and 07b, white Velcro fastener 08 and receptor 09 affixed, respectively, to either side, two tapered flaps/lapels 13a and 13b stowed within 1 cm clearance created by two stamped central creases 10a and 10b.

Referring to FIG. 1I is an open profile perspective view illustrating the fully-extended flaps/lapels 13a and 13b forming working space 15, either side of centerline 14 along vertical axis created by two stamped central creases 10a and 10b, with battery charge indicator 17, Bluetooth adaptor 18 with LED indicator light 19 and mini-solar power source strip 24 on side margins.

Referring to FIG. 1J is a closed profile perspective view illustrating approximate 1 cm clearance 12 between either leaf of composite laminated cardboard ply along centerline 14, two tapered flaps/lapels 13a and 13b stowed within 1 cm clearance 12 created by two stamped central creases 10a and 10b and carry-handles 07a and 07b.

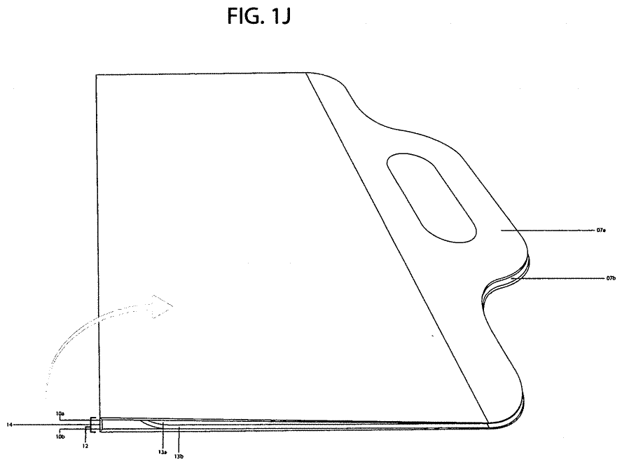

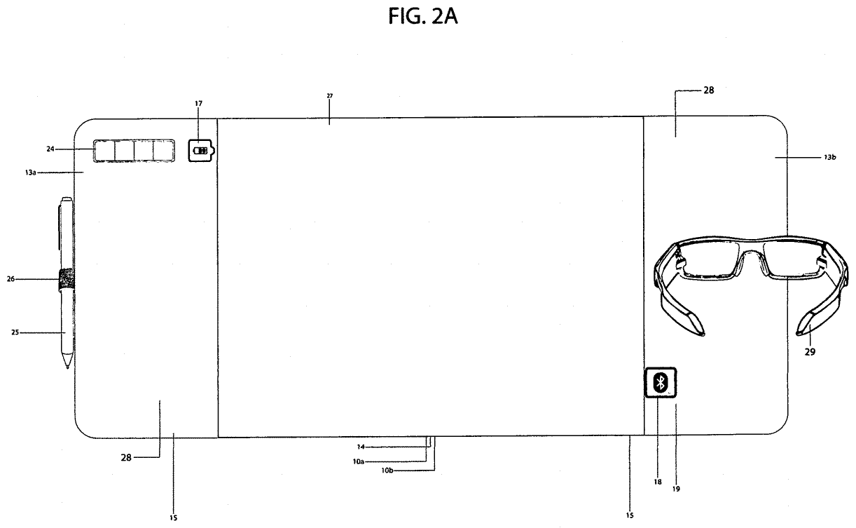

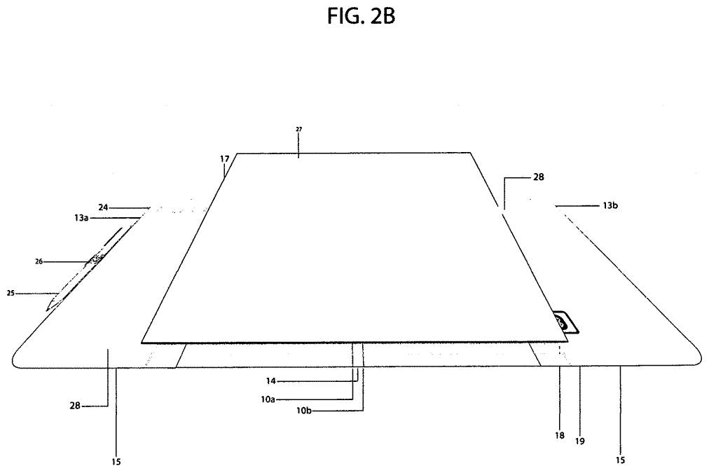

Referring to FIG. 2A is a fully-open perspective view illustrating workspace 15 with a large-size one-piece magnetic vinyl sticker with Stylus pen sensitivity 27 used for MS Office options (Word, Excel & PowerPoint), with optional Stylus pen (optional) 25 in elasticated penholder 26 and Augmented Reality (AR) glasses (optional) 29, as smartphone may also be used to render AR images from AR markers 28 instead of AR glasses 29. View also illustrates the fully-extended flaps/lapels 13a and 13b, either side of centerline 14 along vertical axis created by two stamped central creases 10a and 10b, with battery charge indicator 17, Bluetooth adaptor 18 with LED indicator light 19 and mini-solar power source strip 24 on side margins.

Referring to FIG. 2B is a perspective view of a large-size one-piece magnetic vinyl sticker with Stylus pen sensitivity 27 used for MS Office options (Word, Excel & PowerPoint), with optional Stylus pen (optional) 25 in elasticated penholder 26. View also illustrates the fully-extended flaps/lapels 13a and 13b, either side of centerline 14 along vertical axis created by two stamped central creases 10a and 10b, with battery charge indicator 17, Bluetooth adaptor 18 with LED indicator light 19, mini-solar power source strip 24 and AR markers 28 on side margins.

Referring to FIG. 2C is an exploded cross-sectional view of a large-size one-piece magnetic vinyl sticker with Stylus pen sensitivity 27 used for MS Office options (Word, Excel & PowerPoint), raised above workspace 15, illustrating composition, comprising semi-translucent sheet vinyl 21a bonded to with Stylus pen sensitivity layer 21e, with full-color illustration on upper surface 21c, semi-translucent magnetic sheet 21b and circuitry contacts embedded into lower surface 21d. View also illustrates the fully-extended flaps/lapels 13a and 13b, either side of centerline 14 along vertical axis created by two stamped central creases 10a and 10b, with battery charge indicator 17, Bluetooth adaptor 18 with LED indicator light 19, mini-solar power source strip 24 and AR markers 28 on side margins.

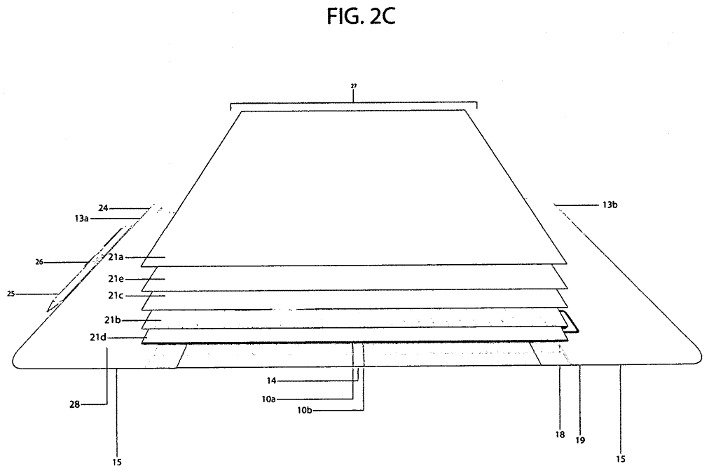

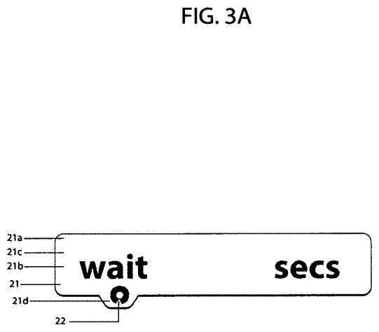

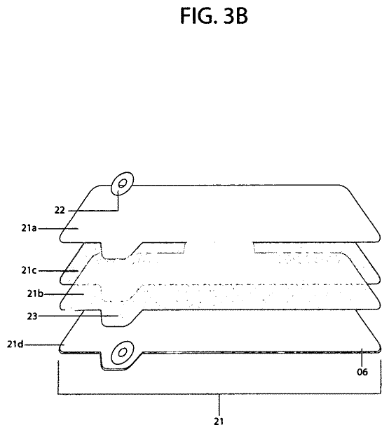

Referring to FIG. 3A is a perspective view, illustrating example of laser-cut sheet magnetic vinyl stickers 21 supplied in groups per curricular subject (e.g. Scratch Coding Blocks, Physics-Chemistry-Math Formulas, English language formulas, etc.) Each magnetic vinyl sticker 21 comprising semi-translucent sheet vinyl 21a bonded to semi-translucent magnetic sheet 21b, with full-color illustration on upper surface 21c, micro-LED light (green/red) 22 affixed to upper surface 21c and access lower surface 21d, in order to engage contact points with PWB (printed wiring board) and/or filament wiring grid on main workspace.

Referring to FIG. 3B is an exploded cross-sectional view of a magnetic vinyl sticker 21 comprising semi-translucent sheet vinyl 21a bonded to semi-translucent magnetic sheet 21b, with full-color illustration on upper surface 21c, micro-LED light (green/red) 22 affixed to upper surface 21c and circuitry contacts 23 on lower surface 21d, that engage with contact points 06 cut into PWB (printed wiring board) and/or filament wiring grid.

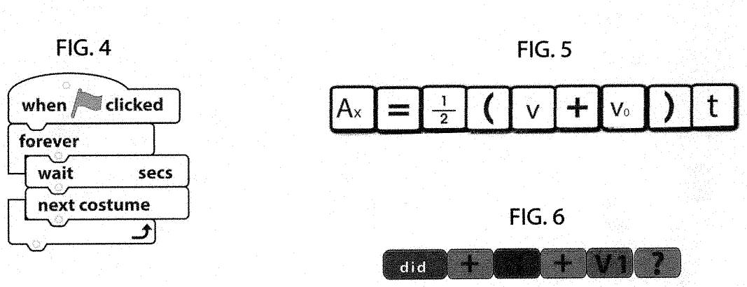

Referring to FIG. 4 is a perspective view of a typical coding magnetic vinyl sticker sequence in which individual magnetic vinyl stickers are stacked in vertical sequences on main workspace.

Referring to FIG. 5 is a perspective view of a typical Physics magnetic vinyl sticker sequence in which individual magnetic vinyl stickers are stacked in horizontal sequences on main workspace.

Referring to FIG. 6 is a perspective view of a typical English language (ESL/EFL) magnetic vinyl sticker sequence in which individual magnetic vinyl stickers are stacked in horizontal sequences on main workspace.

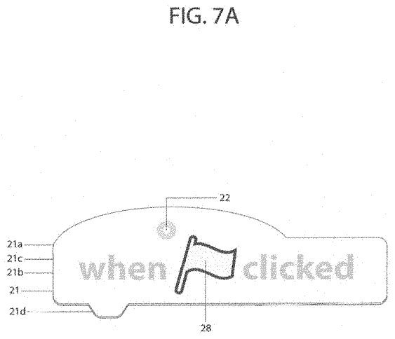

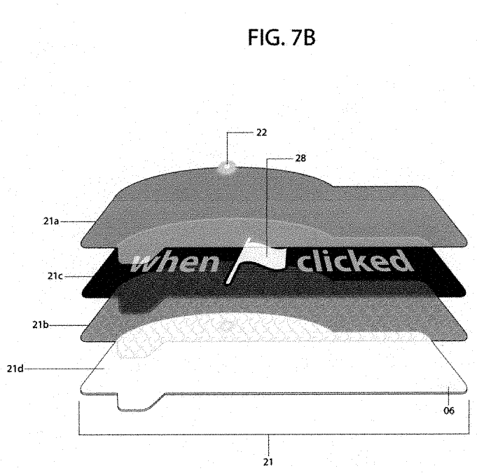

Referring to FIG. 7A is a perspective view of a typical coding magnetic vinyl sticker including an Augmented Reality (AR) marker 28. View also illustrates magnetic vinyl sticker 21 comprising semi-translucent sheet vinyl 21a bonded to semi-translucent magnetic sheet 21b, with full-color illustration on upper surface 21c, micro-LED light (green/red) 22 affixed to upper surface 21c and lower surface 21d.

Referring to FIG. 7B is an exploded cross-sectional view of a typical coding magnetic vinyl sticker 21 including an Augmented Reality (AR) marker 28, comprising semi-translucent sheet vinyl 21a bonded to semi-translucent magnetic sheet 21b, with full-color illustration on upper surface 21c, micro-LED light (green/red) 22 affixed to upper surface 21c and lower surface 21d, that engage with contact points 06 cut into PWB (printed wiring hoard) and/or filament wiring grid.

What is claimed is:

1. A Coding Folder comprising:
The combination of magnetic vinyl stickers in conjunction with a magnetic workspace, incorporating a bonded PWB (printed wiring board) and/or filament wiring grid, enabling vinyl stickers equipped with micro-LED lights and circuitry contacts, to communicate via the Bluetooth connector powered by the onboard rechargeable solar power supply, with IOS/Android App on smartphone/tablet;

2. An OFFLINE Blended-Learning Study Platform comprising:
Kits of magnetic vinyl stickers equipped with micro-LED lights and circuitry contacts, to communicate via the Bluetooth connector powered by the onboard rechargeable battery solar power supply, with IOS/Android App on smartphone/tablet;
Large-size one-piece magnetic vinyl sticker with Stylus pen sensitivity used for MS Office options (Word, Excel & PowerPoint), to communicate areas of one-piece magnetic vinyl sticker when pressed via the Bluetooth connector powered by the onboard rechargeable battery solar power supply, with IOS/Android App on smartphone/tablet, to exhibit handwriting on App screen and references to areas pressed (Word, Excel & PowerPoint commands), for teaching purposes in areas with no Wi-Fi/Internet cover, intermittent/non-dependable electricity mains supply and no PC and/or tablet facilities.
Augmented Reality (AR) markers on workspace and selected magnetic vinyl stickers so that as/when sequences are created and/or completed by Users, creations can “come to life” in AR-mapped 2D and 3D animations displayed on specific AR glasses (optional—if available), or using the same smartphone device employed to run IOS/Android App.

3. Readily AFFORDABLE, OFFLINE, ACTIVE study platform instigating cognitive activity as opposed to PASSIVE “drag&drog” touchscreen technology of tablets/PCs or notebooks/laptops—which, are i) Too expensive for the majority of the world student population; ii) Dependent on reliable electricity grid; iii) Dependent on reliable Internet/Wi-Fi data plans; iv) Not readily transportable due to security concerns; v) Not humidity/heat tolerant; vi) High legacy redundancy rates.
